(19) United States
(12) Patent Application Publication
(10) Pub. No.: US 2013/0170361 A1
(43) Pub. Date: Jul. 4, 2013

(54) System and Method of Interactive call control for calls and connections created in different communication networks

(71) Applicants: Konstantin Manyakin, JR., Toronto (CA); Adiel Rozinov, Richmond Hill (CA)

(72) Inventors: Konstantin Manyakin, JR., Toronto (CA); Adiel Rozinov, Richmond Hill (CA)

(73) Assignee: WEB3TEL INC., Toronto (CA)

(21) Appl. No.: 13/705,049

(22) Filed: Dec. 4, 2012

Related U.S. Application Data
(60) Provisional application No. 61/569,221, filed on Dec. 10, 2011.

(51) Int. Cl. H04L 29/06

(52) U.S. Cl. CPC H04L 29/06176
USPC 370/241

(57) ABSTRACT

A method and system for interactive call control for calls and connections created in different communication networks provide a solution of controlling communication connections originated from different terminals and sources such as landline and mobile phones, soft and hardware based SIP phones, Skype, gTalk or similar communication tools by using the same unified user interface. This method and system employ a desktop computer, tablet or even mobile device equipped with cross-platform application client to send call control commands and to monitor the state of controlled connections through encrypted communication channel with the application server. This server will abstract each terminal in unified way and represent it as a standard SIP enabled device which could be controlled remotely from desktop terminal (DT). Users use drag-and-drop graphical user interface (GUI) to initiate different call control commands such as but not limited to different types of conference and transfer, call initiation, call pickup and monitor the status of controlled calls.

### CROSS-REFERENCE TO RELATED APPLICATIONS

This application claims the benefit of Applicants' prior provisional application, No. [61/569,221], filed on [Dec. 10, 2011].

### MICROFICHE APPENDIX

Not Applicable.

### TECHNICAL FIELD OF INVENTION

This application relates in general to providing of enhanced call control and communications services and, in particular, to a method and system for interactive call control for calls and connections created in different communication networks and for controlling communication connections originated from different terminals and sources such as landline and mobile phones, soft and hardware based SIP phones, Skype, gTalk or similar communication tools by using the same unified user interface.

### BACKGROUND OF THE INVENTION

In the mixed context of Mobile Virtual Network Operators (MVNO) and VoIP providers it is necessary to provide flexible solution for enabling enhanced remote call control features.

Known methods of remote call control have different drawbacks. For example, call control methods based on sending DTMFs can have significant post-dial delay and not user friendly. Another ways of remote call control by using CSTI or uaCSTA protocols requires that terminal should support them.

There therefore exists a need for a method and system that provides effective and user friendly way of interactive call control for calls and connections created in different communication networks.

User are using different communication device and they want to have unified way of controlling them. Existed solutions are mostly intended for using with IP devices and cannot be used with mobile or landline phones or other terminals.

There therefore exists a need for service providers enable a method and system that can provide enhanced call control for calls and connections originated from different terminals and sources such as landline and mobile phones, soft and hardware based SIP phones, Skype, gTalk or similar communication tools by using the same unified user interface.

### BRIEF SUMMARY OF THE INVENTION

It is therefore an object of the invention to provide a method and a system for interactive call control for calls and connections created in different communication networks and provide a solution for controlling communication connections originated from different terminals and sources such as landline and mobile phones, soft and hardware based SIP phones, Skype, gTalk or similar communication tools by using the same unified user interface.

The invention therefore provides a method for interactive call control for calls and connections created in different communication networks in a Voice over Internet Protocol (VoIP), mobile or an IP Multi-Media Subsystem (IMS) network, comprising: authenticating the subscriber by logging procedure from client application; controlling communication connections originated from different terminals and sources such as landline and mobile phones, soft and hardware based SIP phones, Skype, gTalk or similar communication tools by using the same unified user interface by sending call control commands from a desktop computer, tablet or mobile device equipped with cross-platform application client through encrypted communication channel to the call control application server (CCAS); monitoring the state of controlled connections through the same channel; representing connection from different type of devices in uniform way; initiating different call control commands such as but not limited to different types of conference and transfer, call initiation, call pickup and others between devices in uniform ways; receiving call control commands by call control application server; sending notification by CCAS about the status of monitored calls to all signed in monitoring applications; abstracting different types of terminals in unified way and represent it as an instance of standard SIP enabled device in services space of CCAS; traversing all calls and communication through CCAS from these terminals when they are anchored by different ways: calling through local access number service by the service provider; through dedicated DID that belong to destination customer; by using VoIP system of service provider; calling through INUM number, using ENUM or others.

The invention further provides a system for interactive call control for calls and connections created in different communication networks, comprising: cross-platform application resided on desktop computer, tablet or mobile device and programmed to: authenticate the subscriber by logging procedure from desktop application; control communication connections originated from different terminals and sources such as landline and mobile phones, soft and hardware based SIP phones, Skype, gTalk or similar communication tools by using the same unified graphical user interface by sending call control commands over encrypted communication channel to the call control application server (CCAS); monitor the state of controlled connections through the same channel; represent connections from different type of devices and call states in uniform way; initiate different call control commands such as but not limited to different types of conference and transfer, call initiation, call pickup and others between devices through GUI in uniform ways; and a call control application server (CCAS), comprising a service programmed to: receive call control commands from monitoring application; send notifications about the status of monitored calls to all signed in monitoring applications; abstract different types of terminals in unified way and represent it as an instance of standard SIP enabled device; traverse all calls and communication from these terminals when they are anchored by different ways: calling through local access number service by the service provider; through dedicated DID that belong to destination customer; by using VoIP system of service provider; calling through INUM number, using ENUM or others.

The invention further provides a cross-platform application resided on desktop computer, tablet or mobile device, comprising: program instructions for providing graphic user interface which allow users to sign in into the system by entering account credentials; to represent calls and communication connection as uniform graphic abstraction (as a “balloon” or other) placed on the screen of application GUI; by using of drag-and-drop graphical user interface (GUI) to initiate different call control commands such as but not limited to different types of conference and transfer, call initiation, call pickup and monitor the status of controlled calls through encrypted bi-directional communication channel between application and CCAS.

The invention yet further provides a call control application server, comprising: a service application that receives CCM from monitoring application; authenticates this subscriber; extracting call control command and correlating it with specific subscriber and specific instance of anchored call or terminal represented as a SIP abstraction end point; executing corresponding call control commands such as but not limited to different types of conference and transfer, call initiation, call pickup; monitor the state of all anchored calls and sending notifications about the status of monitored calls to all signed in monitoring applications of corresponding subscriber over encrypted channel of IP network.

### BRIEF DESCRIPTION OF THE DRAWINGS

The accompanying drawings incorporated in and forming a part of this specification illustrate several aspects of the invention, and together with the description serve to explain the principles of the invention.

FIG. 1 is a block representation of a communication environment according to one embodiment of the disclosure.

FIG. 2 provides an exemplary communication flow according to the embodiment of the disclosure where the call establishment between 2 terminals is facilitated by interactive call control application.

FIG. 3 is a block representation of an interactive call control application resided on desktop computer, tablet or mobile device according to one embodiment of the disclosure.

FIG. 4 is a block representation of a call control application server according to one embodiment of the disclosure.

### DETAILED DESCRIPTION OF THE PREFERRED EMBODIMENT

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

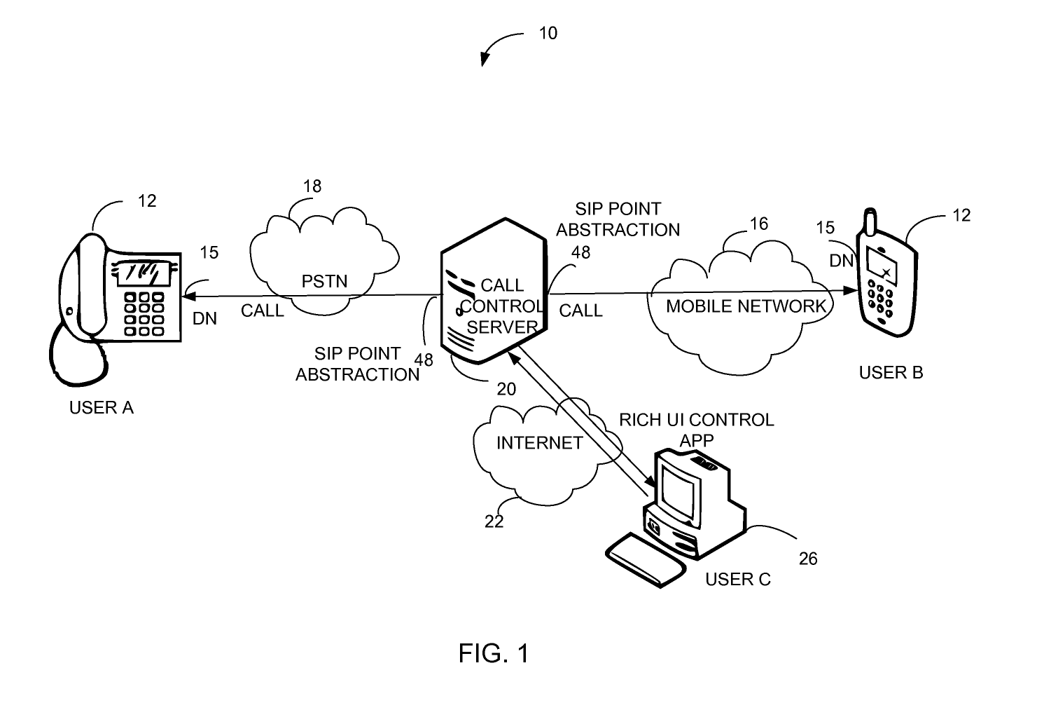

Prior to delving into the details of select embodiments, an overview of an exemplary communication environment 10 is provided in association with FIG. 1. In general, a call control application server (CCAS) 20 is provided to facilitate an example of call establishment between terminals 12 on different communication networks initiated by getting call control messages CCM from monitoring application (interactive call control application) 26. In an exemplary embodiment, the desktop computer equipped with rich user interface monitoring application 26 which is used to send call control message CCM through encrypted channels with information about parties that should be connected, credentials and other information to the call control application server (CCAS) 20. The call control application server (CCAS) 20 will receive this call control message that contains call control command with other parties numbers through correspondent communication; retrieve and verify the subscriber identification and credentials; optionally transforms or normalizes phone numbers existed in call control sequence according to the subscriber specific and formulate call setup requests to the parties numbers 15 (user A and B). These calls will be created as VoIP calls to specific SIP abstraction end points 48 which represent corresponding terminals 12. Given SIP abstraction points 48 will translate these requests into calls through packet 18, mobile network 16 or any other type of networks (for example, initiate Skype call through IP network). The call control application server (CCAS) 20 will monitor the state of all these calls and send notifications about their status to all signed in monitoring applications of corresponding subscriber over encrypted channel of IP network. After successful connections with all 2 parties the call control application server (CCAS) 20 will establish voice connection between user A and user B.

Notably, the devices 12 for user A and B may take virtually any form, including wired or wireless telephones, personal computers with VoIP application, soft and hardware based SIP phones, Skype, gTalk or similar communication tools. The labels provided for these terminals in this description and the following claims are used only to improve readability and separately identify the terminals. Alternatively, the monitoring cross-platform application with rich UI can reside on desktop computer, tablet or mobile device or others and can communicate over encrypted channel of IP network 22 with the call control application server (CCAS) 20.

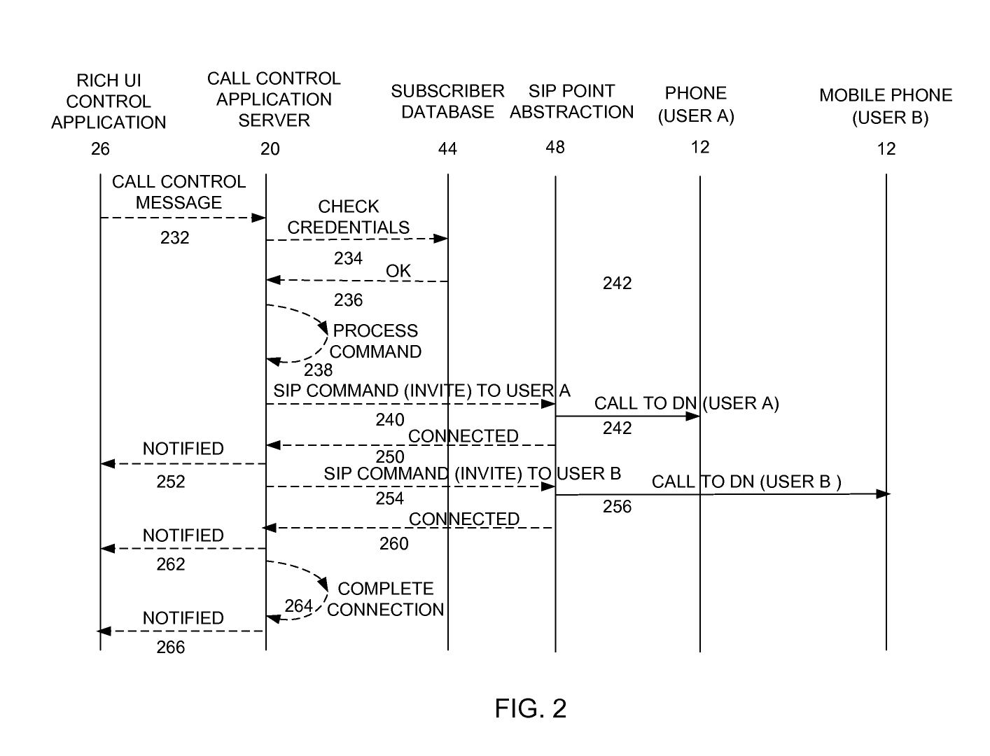

With reference to FIG. 2, a communication flow is provided to illustrate an exemplary scenario for utilizing the rich UI call control application 26 to facilitate a call setup between 2 terminals resided on different communication network by sending call control messages CCM to the server 20. This is only an exemplary scenario of call setup between terminals on PSTN and mobile networks and the aspects and elements represented in the communication flow are not all deemed necessary for implementation of the present invention. For purposes of clarity, the PSTN phone 12 of user A associated with DN A is labelled “Phone (user A) 12”. Likewise the mobile handset 12 of user B associated with DN B is labelled “Mobile Phone (user B) 12”. User C (subscriber) uses the rich UI call control application 26 which provides graphic user interface of sending call control messages CCM to the call control application server 20. The call control application server 20 operates to process call control messages CCM received from the rich UI call control application 26 and later to provide necessary call control functionality. The subscriber database 44 operates to store user profile information, credentials and to provide this information to the service application 40 as requested. In exemplary embodiments, the user database 44 may form a part of the call control application server 20.

At some point, the user C of this rich UI application (subscriber of service) decides to initiate a voice connection between the phones of user A and user B which are essentially on different communication networks. User interaction commands will be translated by this application 26 into call control messages (CCM) containing the called numbers of user A and B, credentials, call control commands and other information and will be sent to the call control application server (CCAS) 20 through encrypted channel of IP network 22 (step 232).

This information will be sent to the call control application server (CCAS) 20 to its service application 40 through corresponding communication interface (step 232) where it will be processed and extracted. In exemplary scenario RESTful API 22 is used as such interface but it can be any type of inter services connectivity.

Now in possession of credentials of user C initiated a call and user A and B DNs (called numbers) the call control application server (CCAS) 20 will check and verify subscriber's information (step 234) In exemplary scenario the call control application server (CCAS) 20 will check subscriber identification and verify it base on credentials provided in incoming call control message (CCM) but other additional information can be also used (step 236). After authentication the call control application server (CCAS) 20 could apply to the called numbers of user A and B corresponding dialing policies and phone number transformation rules and will process a call control command (step 238) (in this case—make a call command).

Now in possession of user A's DN and subscriber credentials the call control application server (CCAS) 20 will locate SIP abstraction points 48 of corresponding terminal and formulate VoIP call setup request to abstraction point of user A's terminal 48 (step 240). Given SIP abstraction point will translate this request into call setup on proper communication network (in this example, on PSTN network) (step 242).

Notification about the connection to the user A terminal will be propagated by correspondent SIP abstraction point 48 to the call control server (CCAS) 20 (step 250) and then to the rich UI application 26 (step 252) through corresponding communication interface 22.

Now in possession of user B's DN and subscriber credentials the call control application server (CCAS) 20 will locate SIP abstraction points 48 of corresponding terminal and formulate VoIP call setup request to abstraction point of user B's terminal 48 (step 254). Given SIP abstraction point will translate this request into call setup on proper communication network (in this example, on mobile network) (step 256).

Notification about the connection to the user B terminal will be propagated by correspondent SIP abstraction point 48 to the call control server (CCAS) 20 (step 260) and then to the rich UI application 26 (step 262) through corresponding communication interface 22.

Now in possession of 2 calls to user A and B terminals the call control application server (CCAS) 20 will formulate and complete the connection (step 264). Notification about the connection will be propagated to the rich UI application 26 (step 266) through corresponding communication interface 22.

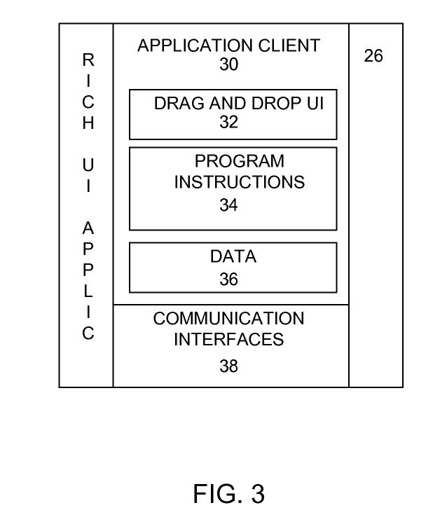

With reference to FIG. 3, a block representation of the rich UI application 26 with an application client 30 is illustrated according to one embodiment. The rich UI application 26 includes an application client 30 having capability of providing interactive interface (for example, drag and drop) and program instructions 34 and data 36 to operate as described above. The program instructions 34 provide the communication functions, data storage and interactive functions which are described above. The application client 30 can send call control messages through communication interface 38 (encrypted channels with RETS API) to provide call control functionality as illustrated in the communication environment 10.

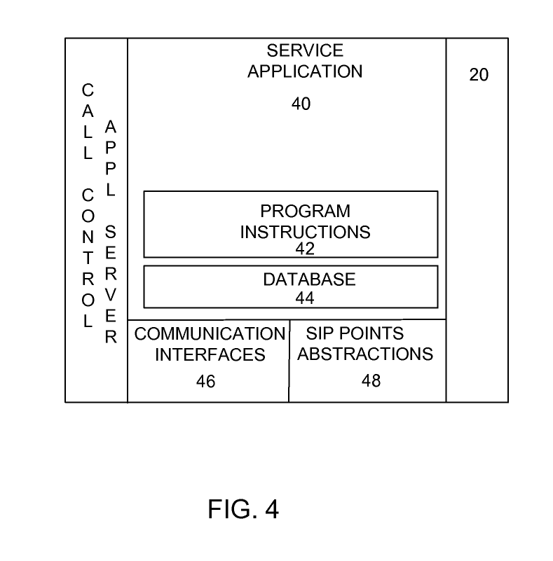

With reference to FIG. 4, a block representation of a call control application server 20 is illustrated. The call control application server 20 includes a service application 40 having capability to store and retrieve subscriber and call specific data in database 44 and program instructions 42 for processing call control message, control call requests to destination DNs as described above through correspondent SIP abstraction points 48. The service application 40 and correspondent SIP abstraction points 48 interact through several communication interfaces 48 with VoIP gateways, PSTN and mobile network to provide call control functionality as described above.

Those skilled in the art will recognize improvements and modifications to the embodiments of the present invention. All such improvements and modifications are considered within the scope of the concepts disclosed herein and the claims that follow.

1. A method for interactive call control for calls and connections created in different communication networks, comprising: authenticating the subscriber by logging procedure from client application; controlling communication connections originated from different terminals and sources such as landline and mobile phones, soft and hardware based SIP phones, Skype, gTalk or similar communication tools by using the same unified user interface by sending call control commands from a desktop computer, tablet or mobile device equipped with cross-platform application client through encrypted communication channel to the call control application server (CCAS); monitoring the state of controlled connections through the same channel; representing connection from different type of devices in uniform way; initiating different call control commands such as but not limited to different types of conference and transfer, call initiation, call pickup and others between devices in uniform ways; receiving call control commands by call control application server; sending notification by CCAS about the status of monitored calls to all signed in monitoring applications; abstracting different types of terminals in unified way and represent it as an instance of standard SIP enabled device in services space of CCAS; traversing all calls and communication through CCAS from these terminals when they are anchored by different ways: calling through local access number service by the service provider; through dedicated DID that belong to destination customer; by using VoIP system of service provider; calling through INUM number, using ENUM or others.

2. The method as claimed in claim 1 wherein authenticating the subscriber through user interface of monitoring application further comprises using subscriber account credentials and sending them to CCAS through encrypted channel.

3. The method as claimed in claim 2 wherein monitoring communication connections originated from different terminals and sources further comprises using representing these connection as uniform graphic abstraction (as a “balloon” or other) placed on the screen of application GUI.

4. The method as claimed in claim 1 wherein controlling communication connections from monitoring application further comprising using of drag-and-drop graphical user interface (GUI) to initiate different call control commands such as but not limited to different types of conference and transfer, call initiation, call pickup and monitor the status of controlled calls.

5. The method as claimed in claim 4 wherein sending call control messages (CCM) from monitoring application comprises formulating a REST like messages containing but not limited to call control command, an identification of the mobile subscriber and his credentials, other relevant information and sending the formulated CCM over encrypted channel of IP network.

6. The method as claimed in claim 4 wherein receiving messages from CCAS over encrypted channel of IP network comprises decoding messages which contains information about the states of connected calls and terminals.

7. The method as claimed in claim 1 further comprising: receiving CCM by call control application server, extracting call control command and correlating it with specific subscriber and specific instance of anchored call or terminal represented as a SIP abstraction end point; executing corresponding call control command.

8. The method as claimed in claim 7 further comprising: monitoring the state of all anchored calls and sending notifications by CCAS about the status of monitored calls to all signed in monitoring applications of corresponding subscriber over encrypted channel of IP network.

9. A system for interactive call control for calls and connections created in different communication networks, comprising: cross-platform application resided on desktop computer, tablet or mobile device and programmed to: authenticate the subscriber by logging procedure from desktop application; control communication connections originated from different terminals and sources such as landline and mobile phones, soft and hardware based SIP phones, Skype, gTalk or similar communication tools by using the same unified graphical user interface by sending call control commands over encrypted communication channel to the call control application server (CCAS); monitor the state of controlled connections through the same channel; represent connections from different type of devices and call states in uniform way; initiate different call control commands such as but not limited to different types of conference and transfer, call initiation, call pickup and others between devices through GUI in uniform ways; and a call control application server (CCAS), comprising a service programmed to: receive call control commands from monitoring application; send notifications about the status of monitored calls to all signed in monitoring applications; abstract different types of terminals in unified way and represent it as an instance of standard SIP enabled device; traverse all calls and communication from these terminals when they are anchored by different ways: calling through local access number service by the service provider; through dedicated DID that belong to destination customer; by using VoIP system of service provider; calling through INUM number, using ENUM or others.

10. Cross-platform application resided on desktop computer, tablet or mobile device, comprising: program instructions for providing graphic user interface which allow users to sign in into the system by entering account credentials; to represent calls and communication connection as uniform graphic abstraction (as a “balloon” or other) placed on the screen of application GUI; by using of drag-and-drop graphical user interface (GUI) to initiate different call control commands such as but not limited to different types of conference and transfer, call initiation, call pickup and monitor the status of controlled calls.

11. The application as claimed in claim 10 further comprising an ability to create a bi-directional encrypted communication channel for sending call control messages and receiving notification from CCAS about the status of calls.

12. A call control application server, comprising: a service application that receives CCM from monitoring application; authenticates this subscriber; extracting call control command and correlating it with specific subscriber and specific instance of anchored call or terminal represented as a SIP abstraction end point; executing corresponding call control commands such as but not limited to different types of conference and transfer, call initiation, call pickup.

13. The call control application server as claimed in claim 12 further comprising: a service application that monitor the state of all anchored calls and sending notifications about the status of monitored calls to all signed in monitoring applications of corresponding subscriber over encrypted channel of IP network.
